(19) United States
(12) Patent Application Publication
(10) Pub. No.: US 2019/0079345 A1
(43) Pub. Date: Mar. 14, 2019

(54) DISPLAY PANEL DEVICE AND MANUFACTURING METHOD

(71) Applicant: HKC Corporation Limited, Shenzhen City (CN)

(72) Inventor: HUAILIANG HE, Shenzhen City (CN)

(21) Appl. No.: 16/141,182

(22) Filed: Sep. 25, 2018

Related U.S. Application Data
(63) Continuation of application No. PCT/CN2018/100598, filed on Aug. 15, 2018.

(30) Foreign Application Priority Data
Sep. 11, 2017 (CN) 201710811435.8

(51) Int. Cl. G02F 1/1335

(52) U.S. Cl. CPC G02F 1/133516; G02F 2001/133357; G02F 1/133528; G02F 1/133603

(57) ABSTRACT

The present invention discloses a display panel and a manufacturing method comprising a first substrate, a second substrate disposed parallel to the first substrate, a liquid crystal layer disposed on the first substrate and the second substrate, a switch unit formed on the second substrate, a color filter layer formed on the switch unit and a flattening layer disposed on the color filter layer; wherein the flat layer comprises a quantum dot material.

### FIELD OF THE DISCLOSURE

The present application relates to the display technology, and more particularly to a display panel and a manufacturing method.

### BACKGROUND

The display, which is generally based on the active switch to control and with the compact size, low power consumption, no radiation and many other advantages, has been widely used. It includes liquid crystal display, OLED (Organic Light-Emitting Diode) display, QLED (Quantum Dot Light Emitting Diodes) displays, plasma displays, etc., from the appearance of view, both with flat-type display and surface-type display.

For the liquid crystal display, it includes two parts: the LCD panel and backlight module. The liquid crystal display includes two glass substrates arranged in parallel and the liquid crystal molecules are placed between the two glass substrates. A voltage is applied between the two glass substrates to control the twist direction of the liquid crystal molecules so that the light of the backlight module can be twisted.

With users' continuous requirements of the screen, the simple RGB (red, green and blue) color film technology has been unable to meet the needs of users'. Improving the display panel device becomes the problem to be solved by the technical people skilled in the art.

### SUMMARY

The purpose of the present invention is to provide a manufacturing method of a display panel device and a way to improve the display effect.

In order to solve the above problems, a display panel device provided in an embodiment of the present application includes: a first substrate; a second substrate disposed parallel to the first substrate;

a liquid crystal layer disposed between the first substrate and the second substrate and a switch unit formed on the second substrate;

a color filter layer formed on the switch unit; a flattening layer disposed on the color filter layer; wherein the flattening layer comprises a quantum dot material. The quantum dot material is a red quantum dot material and a green quantum dot material, wherein the color filter layer comprises a hollow region and the flattening layer comprises a extension portion extending into the hollow region and with the quantum dot material inside.

Besides, the present application provides another display panel device comprising a first substrate; a second substrate disposed parallel to the first substrate;

a liquid crystal layer disposed between the first substrate and the second substrate; a switch unit formed on the second substrate;

a color filter layer formed on the switch unit; a flattening layer disposed on the color filter layer; wherein the flattening layer comprises a quantum dot material.

In one of the embodiment of the present application, the color filter layer comprises a hollow region, the flattening layer comprising an extension portion extending to the hollow region; and the extension portion comprising a quantum dot material. In the present embodiment, the color filter layer is made of a hollow region which is filled by the extension of the flattening layer and used to be a white color resist. And the extension portion also comprises the quantum dot material. The arrangement of the flattening layer avoids to lose the good control of the photolithography etch process and the like, and it is possible to ensure better the forming effect of the etching pattern. The flattening layer is also responsible for forming the quantum dot material of the carrier material, so that the quantum dot material can cooperate better with the color filter layer. The light-emitting quantum material to light source transfer into a multi-color light (usually the color of red, green and blue) and output together with the color filter layer. The purity and brightness, etc. can be improved of the display panel device.

In one embodiment of the present application, the quantum dot material is a red quantum dot material and a green quantum dot material. In the present embodiment, the quantum dot material may be a red quantum dot material and a green quantum dot material, and of course, it may be other colors of quantum dot material. Generally, the red and green quantum dot material are also provided with a backlight comprising a blue backlight group. It could stimulate the red quantum dots and green quantum dots to send out a narrow bandwidth of red and green light, then forming a red, green and blue light output. By cooperating with the color filter layer, the display panel purity and brightness could be upgrade. Besides, the specific quantum dot material may be a compound such as cadmium selenide (CdSe) or zinc sulfide (ZnS).

In one embodiment of the present application, the display panel device comprises a first conductive layer disposed between the liquid crystal layer and the second substrate. In the present embodiment, the first conductive layer is provided on one side of the liquid crystal layer and works with a second conductive layer which is provided on the other side of the liquid crystal layer to apply a voltage and drives the liquid crystal molecules.

In one embodiment of the present application, the display panel device further comprises a second conductive layer. The second conductive layer is disposed on the other side of the liquid crystal layer corresponding to the first conductive layer. In the present embodiment, the second conductive layer is provided on one side of the liquid crystal layer and works with the first conductive layer which is provided on the other side of the liquid crystal layer to apply a voltage and drive the liquid crystal molecules.

In one embodiment of the present application, the color filter layer comprises a red color resist, a green color resist, a blue color resist, and a white color resist. The second substrate further comprises a blocking portion which is between the switch and color filter layers and disposed adjacent to the color resists. The white color resist is disposed between the red color resist and the blue color resist in the same flattening layer. In the present embodiment, the quantum dot material may be applied to a color film substrate comprising a red color resist, a green color resist and a blue color resist, or may be applied to a color film substrate comprising a red, green, blue and white color resist. Generally, it is sufficient that the quantum dot material is applied to the red, green, blue and white color film process. And the problem of saturation of the red, green, blue and white color film process could be in the flat layer by spin coating doping the quantum dots which to be the white color resist of the material layer. It is possible to improve the effect of the purity and brightness of the quantum dot material of the display panel device.

In one embodiment of the present application, the display panel device further comprises a backlight module using a blue light emitting diode as a backlight; a lower side of the switch unit provided with a lower polarizing layer; the backlight module and an upper polarizing layer having an orthogonal relationship with an absorption axis of the lower polarizing layer, the upper polarizing layer containing an iodide molecular adhesive layer; and a gate metal layer of the switch unit disposed adjacent to the absorption axis of the lower polarizing layer of one side of the backlight module. In the present embodiment, the lower polarizing layer and the upper polarizing layer are cooperating with each other, and the two of which are orthogonal to each other, wherein an iodine molecular layer is added to the upper polarizing layer to improve the polarizing effect, and the blue backlight is to activate the red and green quantum dot material to emit light. The flattening layer emits red, green and blue light; wherein the white color resist portion is a main portion of red and green light.

In one embodiment of the present application, the quantum dot material is formed at the flattening layer by spin coating doping. In the present embodiment, the quantum dot material is mainly added to the flattening layer by spin coating doping, and it is, of course, possible to complete the addition of the quantum dot material by other means.

Lastly, a manufacturing method of a display panel device, comprises:

providing a first substrate;

providing a second substrate and forming a switch unit on the second substrate;

a blocking portion provided in an interval above the switch unit, and a color filter layer provided in correspondence with the blocking portion;

forming a flattening layer comprising a quantum dot material over the color filter layer;

forming a lower polarizing layer and a first conductive layer on the outer side of the second substrate and the flat layer; and forming the first substrate and the second substrate, and forming a liquid crystal layer between the first substrate and the second substrate.

The display panel device further comprises a backlight module which is provided on one side of the liquid crystal layer, and the backlight module is disposed on the other side of the liquid crystal layer. A second conductive layer and an upper polarizing layer are sequentially arranged between the liquid crystal layer and the backlight module.

The backlight module adopts a blue backlighting source. The lower side of the switch unit is provided with a lower polarizing layer. An upper polarizing layer is arranged between the backlight module and the liquid crystal layer in an orthogonal relationship with an absorption axis of the lower polarizing layer. The upper polarizing layer comprising an iodide molecular layer; and the gate metal layer of the switch unit is disposed on a side close to the backlight module. The quantum dot material includes a red quantum dot material and a green quantum dot material, and the red quantum dot material and the green quantum dot material are added to the flat layer by spin coating doping.

In the present embodiment, the quantum dot material may be applied to a color film substrate comprising a red, green and blue color resist. Or it may be applied to a color film substrate comprising a red, green, blue and white color resist. Generally, it is sufficient that the quantum dot material is applied to the red, green, blue and white color film process, and the problem of saturation of the red, green, blue and white color film process is in the flat layer by spin coating doping the quantum dots to be the white color resist of the material layer. It is possible to improve the effect of the purity and brightness of the quantum dot material of the display panel device. Besides, the lower polarizing layer and the upper polarizing layer are cooperating with each other, the two of which are orthogonal to each other, wherein an iodine molecular layer is added to the upper polarizing layer to improve the polarizing effect, and the blue backlight is to activate the red and green quantum dot material to emit light. The flat layer emits red, green and blue light, wherein the white color resist portion is a main portion of red and green light.

In one embodiment of the present application, the display panel device comprises a liquid crystal panel, an OLED (Organic Light-Emitting Diode) panel, a QLED (Quantum Dot Light Emitting Diodes) panel, a plasma panel, a planar panel, a curved panel, and the like.

In one embodiment of the present application, the liquid crystal layer is filled with liquid crystal molecules, and the display gray scale of the display panel is controlled by controlling of the deflection angle of the liquid crystal molecules.

The display panel device of the present application wherein the second substrate is a COA substrate (i.e., a Color Filter on Array substrate), wherein a color film substrate is formed on the array substrate and a quantum dot material which is added to the color film substrate. The point material may also be other types of quantum dot material. The red quantum dots, green quantum dots, or blue quantum dots in the quantum dot material will emit light under the excitation of appropriate light such as backlighting. In the structure of the liquid crystal layer and the polarizing layer, the effect of the display panel can effectively improve the purity and brightness of the display panel display device.

### BRIEF DESCRIPTION OF THE DRAWINGS

In order to illustrate the technical solution in the embodiments of the present invention more clearly, the embodiments of the present invention forms a part of the specification for the embodiments of the present application and, together with the description of the text, illustrate the principles of the present application. It is obvious that the figures are merely some embodiments of the present application to those people of ordinary skill in this art who can obtain other embodiments according to these figures without paying the premise.

FIG. 1 is a schematic view of a display panel device of an embodiment of the present application.

FIG. 2 is a flow chart of a process method for displaying a panel of an embodiment of the present application.

FIG. 3 is a schematic representation of the process of the display panel of the present application.

FIG. 4 is a schematic view of a display panel device of an embodiment of the present application.

### DETAILED DESCRIPTION OF PREFERRED EMBODIMENTS

The embodiments of the present application are described in detail with the reference to the accompanying drawings as follows. It is clear that the described embodiments are part of embodiments of the present application, but not all embodiments. Based on the embodiments of the present application, all other embodiments to those of ordinary skill in the premise of no creative efforts acquired should be considered within the scope of protection of the present application.

In the description of the present application, it is to be understood that the terms “center”, “horizontal”, “upper”, “lower”, “left”, “right”, “vertical”, “horizontal”. The orientation or positional relationship indicated by the “bottom”, “inside”, “outside” and the like is based on the azimuth or positional relationship which is shown in the drawings, and that is only for the purpose of facilitating the description of this application and simplified description, rather than indicating or implied meaning or the elements which must have a specific orientation, constructed and operated in a particular orientation, and cannot be construed as limiting the present application. In addition, the terms “first” and “second” are for descriptive purposes only and are not to be construed as indicating or imposing relative importance or implicitly indicating the number of technical features indicated. Thus, a feature that is defined to be a “first” and “second” may expressly or implicitly include one or more of the features. In the description of the present application, unless otherwise indicated, the meaning of “plural” is two or more. In addition, the term “comprising” and any variations thereof are intended to cover non-exclusive inclusion.

In the description of the present application, it should be noted that the terms “install”, “connect” and “connect” should be broadly understood; unless otherwise expressly defined, a fixed connection or a removable Connected, or integrally connected can be a mechanical connection or an electrical connection. It can be directly or indirectly connected by an intermediate medium, which can be connected inside the two components. It will be apparent to those skilled in the art that the specific meaning of the above terms in this application can be understood in particular.

The terminology used herein is for the purpose of describing particular embodiments only and is not intended to limit the exemplary embodiments. Unless the context clearly dictates otherwise, the singular forms “a”, “an”, as used herein, are also intended to comprise the plural. Unless otherwise defined, it should also be understood that the terms “comprising” and/or “comprising”, integers, steps, operations, elements and/or components described herein may be added other features, integers, steps, operations, elements, components, and/or combination.

In the figure, the structures with similar structures are denoted by the same reference numerals.

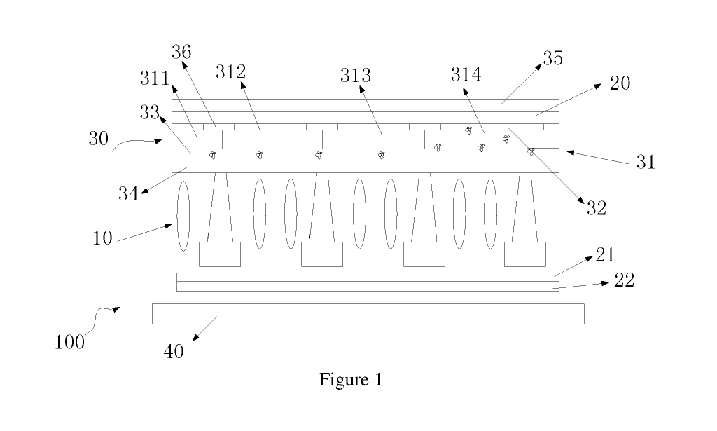

The display panel and the display device of the present application will be described in detail with reference to the embodiments of FIGS. 1 to 4.

FIG. 1 is a schematic view of a display panel according to an embodiment of the present application. By referring to FIG. 1, the present invention discloses a display panel 100 which comprises:

a first substrate;

a second substrate 30 disposed parallel to the first substrate;

a liquid crystal layer 10 disposed between the first substrate and the second substrate 30;

a switch unit 20 formed on the second substrate 30;

a color filter layer 31 formed on the switch unit; and

a flattening layer 33 disposed on the color filter layer 31;

wherein the flattening layer 33 comprises a quantum dot material 32;

The display panel device of the present application comprising the second substrate is a COA substrate (i.e., a Color Filter on Array substrate); wherein a color film substrate is formed on the array substrate and a quantum dot material is added to the color film substrate. The point material may also be other types of quantum dot material. The red quantum dots, green quantum dots, or blue quantum dots in the quantum dot material will emit light under the excitation of appropriate light such as backlighting. In the structure of the liquid crystal layer and the polarizing layer, the effect of the display panel can effectively improve the purity and brightness.

In the present embodiment, the second substrate 30 is provided with a flat layer 33 corresponding to the color filter layer 31. The quantum dot material 32 is provided on the flattening layer 33. As shown in FIG. in one embodiment of the present application, the color filter layer comprises a hollow region and the flattening layer comprises an extension portion extending to the hollow region. The extension portion comprises a quantum dot material. In the present embodiment, the color filter layer is made of a hollow region which is filled by the extension of the flattening layer and used to be a white color resist. The extension portion also comprises quantum dot material. The arrangement of the flattening layer avoids to lose the good control of the photolithography etch process and the like, and it is possible to ensure better the forming effect of the etching pattern. Here, the flattening layer is also responsible for forming the quantum dot material of the carrier material, so that the quantum dot material can cooperate better with the color filter layer to output the specific light-emitting quantum material to light source into a multi-color light (usually red, green and blue), and it could improve the purity and brightness of the display panel device.

In one embodiment of the present application, the quantum dot material includes a red quantum dot material and a green quantum dot material. In the present embodiment, the quantum dot material may be a red quantum dot material and a green quantum dot material, and of course, it may be other colors of quantum dot material. Generally, the red and green quantum dot material are also provided with a backlight comprising a blue backlight group, so as to stimulate the red quantum dots and green quantum dots which send out a narrow bandwidth of red and green light. Thus, a red, green and blue light output cooperate with the color filter layer, then the display panel purity and brightness could be upgraded. Besides, the specific quantum dot material may be a compound, such as cadmium selenide (CdSe) or zinc sulfide (ZnS).

In one embodiment of the present application, the display panel device 100 comprises a first conductive layer 34 which is disposed between the liquid crystal layer 10 and the second substrate 30. In the present embodiment, the first conductive layer is provided on one side of the liquid crystal layer and works with a second conductive layer which is provided on the other side of the liquid crystal layer to apply a voltage to the liquid crystal layer to drive the liquid crystal molecules.

In one embodiment of the present application, the display panel device 100 further comprises a second conductive layer 21, and the second conductive layer 21 is disposed on the other side of the liquid crystal layer 10 corresponding to the first conductive layer 34. In the present embodiment, the second conductive layer is provided on one side of the liquid crystal layer and works with the first conductive layer which is provided on the other side of the liquid crystal layer to apply a voltage and drive the liquid crystal molecules.

In one embodiment of the present application, the color filter layer 31 comprises a red color resist 311, a green color resist 312 and a blue color resist 313. The second substrate 30 further comprises a blocking portion 36 which is between the switch and color filter layers 31 and disposed adjacent to the color resists 314. The color resists 314 is disposed between the red color resist 311 and the blue color resist 313 in the same flattening layer. In the present embodiment, the quantum dot material may be applied to a color film substrate comprising a red, green and blue color resist. Or it may be applied to a color film substrate comprising a red, green, blue and white color resist. Generally, it is sufficient that the quantum dot material is applied to the red, green, blue and white color film process, and the problem of saturation of the red, green, blue and white color film process could enhance the effect of the purity and brightness of the quantum dot material by spin coating doping in the flat layer being the white color resist.

In one embodiment of the present application, the display panel device 100 further comprises a backlight module 40 using a blue light emitting diode as a backlight. A lower side of the switch unit 20 is provided with a lower polarizing layer 35. The backlight module 40 and an upper polarizing layer 10 have an orthogonal relationship with an absorption axis of the lower polarizing layer 35, and the upper polarizing layer comprising an iodide molecular adhesive layer 22. A gate metal layer of the switch unit is disposed adjacent to the absorption axis of the lower polarizing layer of one side of the backlight module.

In the present embodiment, the lower polarizing layer and the upper polarizing layer are cooperating with each other. The two of which are orthogonal to each other, wherein an iodine molecular layer is added to the upper polarizing layer to improve the polarizing effect, and the blue backlight is to activate the red and green quantum dot material to emit light. The flat layer emits red, green and blue light, wherein the white color resist portion is a main portion of red and green light.

In one embodiment of the present application, the quantum dot material 32 is formed at the flattening layer 33 by spin coating doping. In the present embodiment, the quantum dot material is mainly added to the flattening layer by spin coating doping, and it is, of course, possible to complete the addition of the quantum dot material by other means.

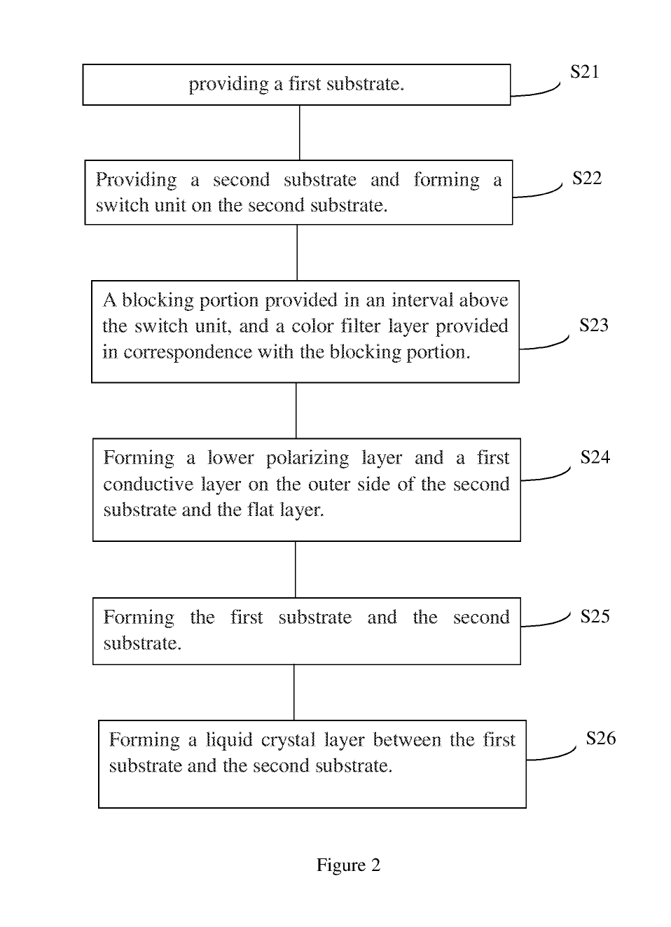

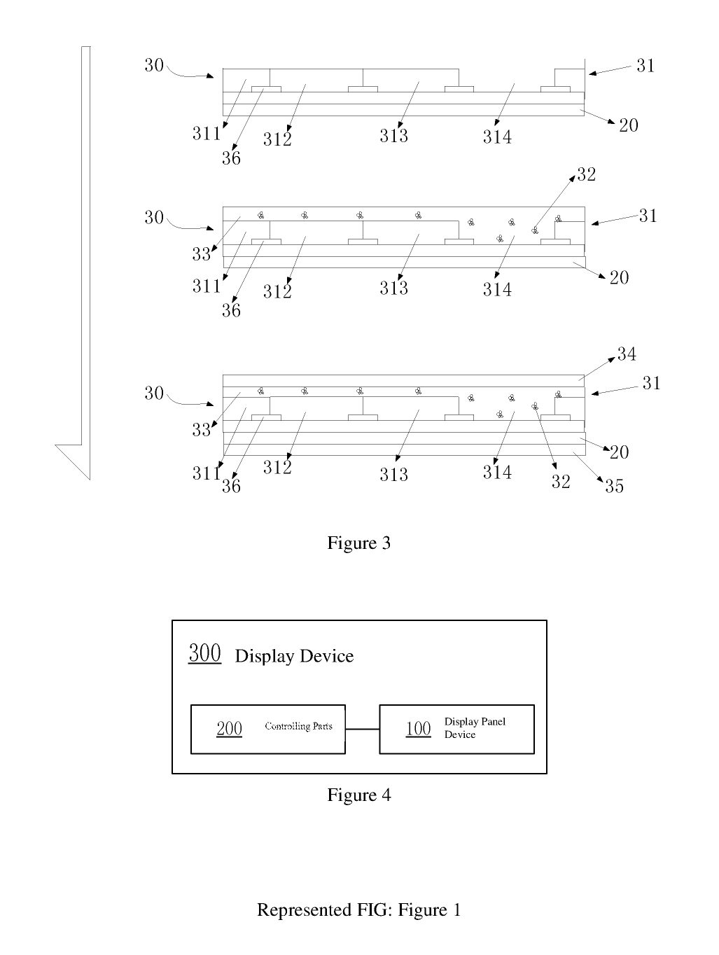

FIG. 2 is a flow chart of a manufacturing method according to an embodiment of the present application. FIG. 3 is a schematic view of a manufacturing process of a display panel device according to an embodiment of the present application. By referring to FIGS. 2 and 3, the present application also discloses a display of manufacturing method, which comprises:

S21: providing a first substrate;

S22: providing a second substrate 30 and forming a switch unit 20 on the second substrate 30;

S23: a blocking portion 36 provided in an interval above the switch unit 20, and a color filter layer 31 provided in correspondence with the blocking portion 36;

S24: forming a flattening layer 33 comprising a quantum dot material 32 over the color filter layer 31;

S25: forming a lower polarizing layer 35 and a first conductive layer 34 on the outer side of the second substrate and the flat layer 33; and

S26: forming the first substrate and the second substrate 30, and forming a liquid crystal layer 10 between the first substrate and the second substrate 30.

The display panel device of the present application comprising the second substrate is a COA substrate (i.e., a ColorFilter on Array substrate); wherein a color film substrate is formed on the array substrate and a quantum dot material is added to the color film substrate. The point material may also be other types of quantum dot material. The red quantum dots, green quantum dots, or blue quantum dots in the quantum dot material will emit light under the excitation of appropriate light such as backlighting. In the structure of the liquid crystal layer and the polarizing layer, the effect of the display panel can effectively improve the purity and brightness.

Wherein the main invention of the display panel device is not the array substrate part and the color film substrate, so it is only briefly mentioned here, and will not be described again.

The display panel device 100 further comprises a backlight module 40 provided on one side of the liquid crystal layer 10, and the backlight module 40 is disposed on the other side of the liquid crystal layer 10. A second conductive layer 21 and an upper polarizing layer 22 are sequentially arranged between the liquid crystal layer 10 and the backlight module. The backlight module adopts a blue backlighting source. The lower side of the switch unit 20 is provided with a lower polarizing layer 35. An upper polarizing layer 22 is arranged between the backlight module and the liquid crystal layer 10 in an orthogonal relationship with an absorption axis of the lower polarizing layer. The upper polarizing layer 22 comprises an iodide molecular layer. The gate metal layer of the switch unit is disposed on a side close to the backlight module; and the quantum dot material 32 is a red quantum dot material and a green quantum dot material. The red and green quantum dot material is added to the flattening layer 33 by spin coating doping. In the present embodiment, the quantum dot material may be applied to a color film substrate comprising a red, green and blue color resist, or may be applied to a color film substrate comprising a red, green, blue and white color resist. Generally, it is sufficient that the quantum dot material is applied to the red, green, blue and white color film process, and the problem of saturation of the red, green, blue and white color film process in the flat layer by spin coating doping the quantum dots to be the white color resist of the material layer. It is possible to improve the effect of the purity and brightness of the quantum dot material of the display panel device. Besides, the lower polarizing layer and the upper polarizing layer are cooperating with each other, and the two of which are orthogonal to each other; wherein an iodine molecular layer is added to the upper polarizing layer to improve the polarizing effect, and the blue backlight is to activate the red and green quantum dot material to emit light. The flat layer emits red, green and blue light, wherein the white color resist portion is a main portion of red and green light.

In one embodiment of the present application, the display panel device comprises a liquid crystal panel, an OLED (Organic Light-Emitting Diode) panel, a QLED (Quantum Dot Light Emitting Diodes) panel, a plasma panel, a planar panel, a curved panel, and the like. For a liquid crystal display panel, the liquid crystal layer is filled with liquid crystal molecules, and the display gray scale of the display panel is controlled by the controlling of the deflection angle of the liquid crystal molecules.

FIG. 4 is a schematic view of a display device according to an embodiment of the present invention. By referring to FIG. 4, the present embodiment discloses a display device 300. The display device 300 comprises a control unit 200 and a display panel device 100 which is described in the present application. The above description of the display panel device structure is also applicable to the display of the embodiment of the present application; wherein the display device of the embodiment of the present application is a liquid crystal display, and the liquid crystal display comprising a backlight module. The backlight module can be used as a light source for supplying a sufficient light source with uniform brightness and distribution. The backlight module of the present embodiment may be either a front light type or a backlight type. It needs to be noted that the backlight module is not limited to the present embodiment.

The above embodiment is a detailed description of the present application in connection with specific preferred embodiments, and it is not to be determined or limited to that the specific implementation of the present application to these illustrations. It will be apparent to those skilled in the art from this disclosure that various modifications or substitutions may be made without departing from the spirit of the present application and are intended to be within the scope of the present application.

What is claimed is:

1. A display panel, comprising:
a first substrate;
a second substrate disposed parallel to the first substrate;
a liquid crystal layer disposed between the first substrate and the second substrate;
switch units formed on the second substrate;
a color filter layer formed on the switch unit;
a flattening layer disposed on the color filter layer;
wherein the flattening layer comprises a quantum dot material;
wherein the quantum dot material comprises a red quantum dot material and a green quantum dot material;
wherein the color filter layer comprises a hollow region and the flattening layer comprises a extension portion extending into the hollow region and having the quantum dot material inside.

2. A display panel device comprising:
a first substrate;
a second substrate disposed parallel to the first substrate;
a liquid crystal layer disposed between the first substrate and the second substrate;
a switch unit formed on the second substrate;
a color filter layer formed on the switch unit;
a flattening layer disposed on the color filter layer;
wherein the flattening layer comprises a quantum dot material.

3. The display panel device according to claim 2, wherein the color filter layer comprises a hollow region, the flattening layer comprises an extension portion extending into the hollow region; and the extension portion comprises a quantum dot material.

4. The display panel device according to claim 3, wherein the quantum dot material is formed in the flattening layer by the spin coating doping.

5. The display panel device according to claim 3, wherein the hollow area is a white color resist.

6. The display panel device according to claim 3, wherein the display panel comprises a first conductive layer disposed between the liquid crystal layer and the second substrate.

7. The display panel device according to claim 6, wherein the display panel device further comprises a second conductive layer, and the second conductive layer is on the other side of the liquid crystal layer corresponding to the first conductive layer.

8. The display panel according to claim 6, wherein the color filter layer further comprises red color resist, green color resist and blue color resist;
the second substrate further comprises a blocking portion disposed between the switch unit and the color filter layer and disposed adjacent to the color resists; and
the hollow region is disposed between the red color resist and the blue color resist in the same flattening layer.

9. The display panel device according to claim 8, wherein the display panel device further comprises a backlight module using a blue light emitting diode as a backlighting source;
a lower polarizing layer is disposed on an outside periphery of the switch unit;
an upper polarizing layer is disposed between the backlight module and the liquid crystal layer and is in the orthogonal relationship with an absorption axis of the lower polarizing layer;
the upper polarizing layer comprises an iodine molecular adhesive layer; and
the gate metal layer of the switch unit is disposed on the side close to the backlight module.

10. The display panel device according to claim 2, wherein the quantum dot material comprises a red quantum dot material, a green quantum dot material, and a blue quantum dot material.

11. The display panel according to claim 2, wherein the quantum dot material comprises cadmium selenide.

12. The display panel according to claim 2, wherein the quantum dot material comprises zinc sulfide.

13. The display panel according to claim 2, wherein the quantum dot material is a red quantum dot material and a green quantum dot material.

14. A manufacturing method of a display panel device, comprising:
providing a first substrate;
providing a second substrate and forming a switch unit on the second substrate;
a blocking portion provided in an interval above the switch unit, and a color filter layer provided in correspondence with the blocking portion;
forming a flattening layer comprising a quantum dot material over the color filter layer;
forming a lower polarizing layer and a first conductive layer on the outer side of the second substrate and the flat layer; and
forming the first substrate and the second substrate, and forming a liquid crystal layer between the first substrate and the second substrate.

15. The manufacturing method according to claim 14, wherein the display panel device further comprises a backlight module provided on one side of the liquid crystal layer, and the backlight module is disposed on the other side of the liquid crystal layer;
a second conductive layer and an upper polarizing layer are sequentially arranged between the liquid crystal layer and the backlight module;
the backlight module adopts a blue backlighting source;
the lower side of the switch unit is provided with a lower polarizing layer;
an upper polarizing layer is arranged between the backlight module and the liquid crystal layer in an orthogonal relationship with an absorption axis of the lower polarizing layer, the upper polarizing layer containing an iodide molecular layer;
the gate metal layer of the switch unit is disposed on a side close to the backlight module; and
the quantum dot material comprises a red quantum dot material and a green quantum dot material, and the red quantum dot material and the green quantum dot material is added to the flat layer by spin coating doping.

16. The manufacturing method according to claim 14, wherein the quantum dot material comprises a red quantum dot material, a green quantum dot material, and a blue quantum dot material.

17. The manufacturing method according to claim 14, wherein the quantum dot material comprises cadmium selenide.

18. The manufacturing method according to claim 14, wherein the quantum dot material comprises zinc sulfide.

19. The manufacturing method according to claim 14, wherein the color filter layer comprises a hollow region comprising an extension portion of the flattening layer filled in a hollow region;
the extension portion comprises a quantum dot material.

20. The manufacturing method according to claim 19, wherein the color filter layer further comprises red color resist, green color resist and blue color resist;
the blocking portion being disposed between adjacent two color resists; and
the hollow area being provided between said red color resist and the blue resist, and flat layer is on the same layer.
